(19) United States
(12) Patent Application Publication
(10) Pub. No.: US 2002/0154590 A1
(43) Pub. Date: Oct. 24, 2002

(54) Optical storage medium with virtual track pitch

(76) Inventors: Dmitri V. Vezenov, Natick, MA (US); John M. Guerra, Concord, MA (US); Leonard Wan, Chestnut Hill, MA (US); Paul F. Sullivan, Westwood, MA (US); Kenric P. Nelson, Montclair, NJ (US)

Correspondence Address: KNOBBE MARTENS OLSON & BEAR LLP, 2040 MAIN STREET, FOURTEENTH FLOOR, IRVINE, CA, 91614, US

(21) Appl. No.: 09/842,098

(22) Filed: Apr. 25, 2001

Related U.S. Application Data
(60) Provisional application No. 60/285,497, filed on Apr. 19, 2001.

(51) Int. Cl. G11B 7/135

(52) U.S. Cl. 369/112.26

(57) ABSTRACT

An optical data storage medium includes a superstructure of micro-lenses defining first and second repeating periods. One of the periods is longer than the other, and the presence of the longer repeating period allows the medium to be used in an optical drive that is configured to use light diffracted by the longer period for tracking purposes. The micro-lenses may be configured such that adjacent lenses have different heights, widths, or shapes. In some embodiments, the spacing between adjacent data tracks is varied to provide the first and second repeating periods.

### CROSS REFERENCE TO RELATED APPLICATIONS

This application claims priority under 35 U.S.C. 119(e) to U.S. Provisional Patent Applicaiton Serial No.______, entitled Microlens Structure, Manufacture, and Use, filed on Apr. 19, 2001.

### BACKGROUND OF THE INVENTION

1. Field of the Invention

The present invention relates to optical data storage.

2. Description of the Related Art

FIG. 1 illustrates a standard optical storage system 100 comprising an objective lens 11, such as found in a Digital Versatile Disc (DVD) head, and a conventional recording medium 20, such as an optical or magneto-optical recording disc. The recording medium 20 typically comprises a storage layer disposed upon a substrate, with data encoded thereon by means of optical artifacts (or spots) formed in a medium surface 25 as it moves relative to objective lens 11, as indicated by arrow 19. Recording medium 20 may further comprise a transparent protective layer disposed on the medium surface (which is not shown in FIGS. 1 or 2). Recording medium 20 is typically in a track format in which tracks are formed concentrically or spirally in the circumferential direction and optical artifacts, each consisting of a recording unit of information, are recorded in the form of an optically detectable pattern along the track(s).

The storage layer may or may not be re-writeable by an optical drive. In re-writeable systems, information may be written to the medium surface 25 by irradiating local spots of the medium surface 25 with a laser beam. The irradiation may selectively heat local spots so that pits are formed selectively at the local spots. Alternatively, the reflectivity of regions of the media may be changed by causing light induced chemical or physical changes to the layer of recording material. The information thus written on the medium surface 25 may be optically read, based on a variation in the amount of a read beam reflected from the medium surface 25, or by utilizing the magneto-optical effect, for example.

The reading of data is accomplished by means of an optical pick up unit (OPU) incorporating a relatively low power laser beam focused through lens 11 to a small spot on the track. A portion of the light is reflected off the disc 20 and is reflected off the semitransparent mirror 17 to a photo detector 18 as reflected radiation 15. The photo detector 18 recognizes surface features which may cause changes in the intensity of the reflection, changes in the phase of the reflected light (typically caused by changes in depth, e.g. pits or bumps), or changes in the state of polarization of the reflected light.

The data density on the optical disk is determined to a large extent by the spot size of the focused beam reading recorded data marks from the optical disk. The full-width at 1/e² (e—base of the natural logarithm) intensity spot size, s, for Gaussian illumination at the stop can be estimated as:

S_{(1/e)}²=λ/NA

The minimum data track pitch that is still resolved by the drive optics is:

Pₘᵢₙ=λ/(2NA)

The actual track pitch found in practice is typically a compromise between the above values, so that there is, on one hand, sufficient overlap between 0-th and 1-st diffracted orders to provide tracking information and, on the other hand, sufficient separation between data tracks is provided to prevent cross-talk (in the form of cross-erasure and cross-read). The minimum average (e.g. in the case of non-equivalent tracks) recording track pitch is typically on the order of 0.6λ/NA (corresponding to spot's full width at half maximum intensity). This size results in minimizing signal deterioration trough cross-erasure and also tolerable cross-talk from adjacent tracks during read out, if additional cross-talk suppression schemes are used. This size is sufficiently large for individual tracks to be resolved (i.e. >0.5λ/NA). For example, current commercial standard DVD drives (with λ=650-660 nm and NA=0.6-0.65) use media with 0.74 μm data track pitch (with a groove track pitch, i.e. distance between grooves, of either 0.74 μm or 0.74 μm×2=1.48 μm), which is well above the resolution of the detecting system: Pₘᵢₙ=0.50-0.55 μm.

As the density of stored information is further increased, an even smaller data spot is utilized in the process of writing to, or reading from, recording medium 20. In order to narrow the focus area of laser 13, recently developed optical recording technology has implemented a micro-lens superstructure onto the surface of optical recording discs, as described in U.S. Pat. Nos. 5,910,940 and 6,115,348 to Guerra, both of which are herein incorporated by reference in their entireties. FIG. 2 illustrates such a system including a lens 11, optical disc 20, and a plurality of micro-lenses 202. The use of an array of prismatic elements 202 (micro-lenses) in conjunction with objective lens 11 provides a narrower focus on the surface of disc 20 for detection of spots. In addition, the narrower focus, achieved through the use of micro-lenses 202, may allow the tracks to have a smaller pitch (i.e. to be closer to one another radially), again allowing more data to be stored on the optical disc.

Appropriately shaped structures for micro-lenses have been created by molding the shapes from a substrate called a “stamper.” Stampers for micro-optic arrays have been fabricated with a number of techniques, including fabrication of a master with precision computer-controlled diamond turning, photolithography, multiple or single beam laser lithography, laser mastering lathe, or e-beam lithography. The stamper itself is typically the end product of a one or multiple step serial replication of the original master. The stamper may then be used to fabricate the micro-optic structure that is formed into an optical data storage medium. The micro-optic shaped geometric structure may be created from the stamper, using methods such as compression, injection, or sequential injection/compression molding. The micro-optic structure may be fabricated by a plastic injection and/or compression molding process using the stamper as part of the mold.

Thus, micro-lenses may be created in much the same way as the pits and grooves of standard CD or DVD disks. A master disk is produced with the same steps, for instance exposure of a glass disk coated with photo-resist on a laser mastering machine (also called a Laser Beam Recorder or LBR) and subsequent development of the photo resist. Instead of pits or flat-bottomed continuous grooves, the exposure parameters are adjusted to create grooves with a semicircular profile at their bottoms. Such profiles can be generated by modifications of the exposure parameters similar to those which are taught in, for instance, Principles of Optical Disk Systems (incorporated by reference herein in its entirety) for combining header pits with a tracking pregroove (see e.g. page 194) A nickel replica of the master, also called a stamper, perhaps removed by a few replication generations, is used in an injection molding machine to form blanks, typically made of polycarbonate, having the same geometry as the master. (If the master is formed using the type of photo-resist that becomes more permanent with light exposure rather than less permanent, an even number of nickel replications will give a blank having the complementary and, in this case, desired geometry.) The grooved polycarbonate blanks are then filled with a high index dielectric followed by the other layers of a standard disk structure. Since the disk is normally viewed through the polycarbonate layer by the drive, the high index dielectric presents the desired convex surface to the drive.

Some optical storage systems, including DVD, use a so-called push-pull tracking servo system. In such a system, the plus and minus first order diffraction patterns are interfered with the zero order diffraction pattern to get the necessary tracking error signal (“TES”). The angle of the diffraction orders increases as the pitch of the tracks decreases. With the use of micro-optical elements, because the probe spot size reduction is achieved with respect to the near field of the micro-optical elements (through increase in the effective NA in the near field, NA_{NF}), the full potential of the size reduction cannot be used for data track sizes smaller than the resolution limit of the far field information retrieval system, μ/(2NA_{FF}), because individual tracks will not be distinguishable to the drive optics. It would therefore be advantageous to be able to use conventional tracking servo systems with higher track density disks.

### SUMMARY OF THE INVENTION

In one embodiment, the invention comprises an optical data storage medium comprising a recording layer having a micro-lens array affixed to the surface thereof, wherein said micro-lens array comprises a radially periodic structure defining at least first and second repeating periods for use in tracking in an optical reader. In one advantageous embodiment useful in currently commercially available DVD drives, first repeating period is about 740 nm, and said second repeating period is about 370 nm. In this embodiment, the presence of the longer first repeating period allows an optical data storage medium having twice the normal track pitch to be used in a conventional DVD drive.

In another embodiment, an optical storage medium comprises a first spiral track for recording optical artifacts having a track pitch of N microns, and a second spiral track for recording optical artifacts having a track pitch of N microns. Preferably, the first track and said second track are interleaved such that there is an average track pitch of N/2 microns between the first and second tracks. In an especially advantageous embodiment, the first track is disposed a first distance from the second track in a first direction and is disposed a second distance from the second track in a second direction. Methods of making optical data storage media are also provided. In one embodiment, such a method comprises fabricating a stamper having one or more grooves therein, wherein at least different portions of the one or more grooves have different physical characteristics.

### BRIEF DESCRIPTION OF THE DRAWINGS

FIG. 1 is a perspective diagrammatic view a conventional optical storage system including a optical disc.

FIG. 2 is a cross section of an optical disc including micro-lenses.

FIG. 3 is a top view of an optical disc master having interleaved spiral grooves.

FIG. 4 is a top view of an optical disc master having a single spiral groove.

FIG. 5A illustrates a cross section of an optical disk having height modulated micro-lenses.

FIG. 5B illustrates a cross section of an optical disc having width modulated micro-lenses.

FIG. 6A is a cross section of an optical disk having varying track pitch, wherein the variation has period N.

FIG. 6B is a cross section of an optical disc having varying track pitch with shape modulated micro-lenses.

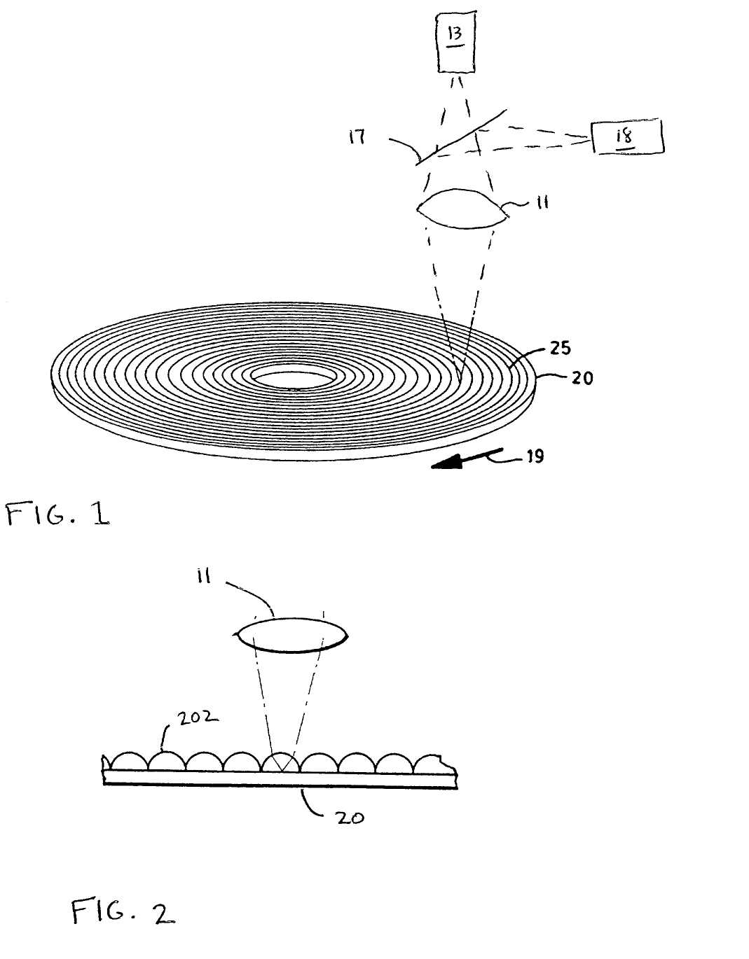

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Using methods and systems as described herein, positioning (tracking) of a far field optical pick-up unit (OPU) may be performed to follow data tracks with sizes P_{track}, that are under OPU's resolution limit:

P_{track}<λ/(2NA_{FF})

This may be attained by introducing optical storage media where micro-optical elements have regular (alternating) perturbations of their topographical (geometrical) characteristics so as to introduce a period into overall disk structure that is larger than the size of the actual data track, i.e. a virtual track pitch. The perturbations may advantageously be designed in a such a way as to: 1) minimize the differences in the data readout signal when the beam is focused at the individual tracks; 2) maximize the resulting tracking error signal, e.g. maximize the diffraction efficiency for the first order and set optimum phase differences between the 0-th and the 1-st orders; and 3) minimize the cross-talk between adjacent tracks during readout of written data.

In one advantageous embodiment useful in current commercial DVD drives, the 0.37 μm micro-optical elements (lenses) will be used to define individual data tracks of the 0.37 μm size, which will not be readable in the DVD drive (0.37 μm<Pₘᵢₙ). By introducing small perturbations of opposite sense in odd and even micro(nano)-cylinders, the optics of the DVD drive can be referenced to the virtual track pitch of 0. 74 μm expected by the drive. By knowing the relationship between the coarse resolved pattern and fine unresolved pattern, the drive OPU may directed to individual data tracks by many methods, including without limitation one or more of tracking to negative or positive TES slope, interpolation, offset or some other means by the drive electronics.

When using some embodiments of the invention, the storage density of an optical disc is thus increased by using a smaller track pitch, while allowing the optical disc to be accessed (write and read) by current, industry standard optical drives. In advantageous embodiments of the invention, micro-lenses are utilized in creating an optical disc with a decreased track pitch. By controlling characteristics of the micro-lenses, a “virtual” track pitch is formed, which may be used by a conventional tracking servo system, allowing currently commercially available optical drives to access the disc. In one advantageous embodiment, the invention allows an optical disc reader, which has a tracking servo designed for a track pitch of N microns, to read an optical disc with a physical track pitch of N/2 microns. This may be accomplished through the use of alternating micro-lens characteristics between tracks (having a track pitch of N/2 microns) creating a virtual track pitch of N microns, which is readable by the optical disc reader. For example, in one embodiment of the invention a DVD is created having a physical track pitch of 0.37 microns, while having a virtual track pitch of 0.74 microns, allowing the DVD to be read by current, industry standard DVD drives.

Throughout this document, a DVD disc and DVD reader will be used for exemplary purposes to help explain aspects of the present invention. It will be appreciated by a person of ordinary skill in the optical recording art that the present invention applies to any optical storage medium, such that any type of optical recording medium may be fabricated to comprise a virtual track pitch larger than the physical track pitch.

As discussed above, a typical tracking system creates a tracking error signal (TES) by measuring the light intensity reflected from the disk surface that is received by one or more photo diodes. For conventional DVD drives, the track pitch is 0.74 microns, and the NA of the objective is designed to receive the first order diffraction for this expected pitch. For smaller track pitches, the NA of the objective is too small to receive this reflected light, with the result that the conventional tracking servo system no longer functions properly.

Any regularly recurring physical pattern will reflect incident light in a diffraction pattern indicative of the periodicity of the pattern. In the case of a complex pattern with components of several different periods, the diffraction is not very high contrast, but for a simple patterns the contrast is quite significant. By alternating the physical characteristics of adjacent tracks on an optical disk, a fundamental periodicity of N is produced, even though the actual track pitch is N/2. This produces reflected light in a pattern associated with track pitch N for use by the tracking servo system, but from a disk with actual track pitch N/2.

Referring back to FIG. 2, and as described in the Guerra patent mentioned above, the micro-lens superstructure may be fabricated by forming a master with a groove or grooves corresponding to the desired hemicylindrical lens shape and lens position. (As will be apparent to one skilled in the art, these “grooves” may be “bumps”, depending on the particular mastering process chosen.) A nickel replica, of an even or odd generation depending on the mastering process, may be used as part of a mold in a compression or injection or compression/injection molding process to form the shape of the lens superstructure as concavities into a disk blank. Subsequent filling of this shape with a high index dielectric actually forms the micro-lenses. As will be described below, the master may comprise a series of concentric circular grooves, a single spiral groove, or two or more interleaved spiral grooves. In advantageous embodiments of the invention, data is recorded in one or more tracks which follow the path of the lens superstructure.

In advantageous embodiments of the invention, the shape and/or position of the grooves in the master, and thus the physical characteristics of the micro-lenses associated with the tracks, are controlled to produce a periodic superstructure on the disk surface having a period which is greater than, and an integral multiple of, the actual physical track pitch. A variety of physical characteristics may be adjusted to provide this “virtual” pitch. For example, the width, height, radius, or shape of alternating micro-lenses may be altered, as described further below. As another alternative, the spacing between adjacent micro-lenses may alternate between a smaller distance and a larger distance.

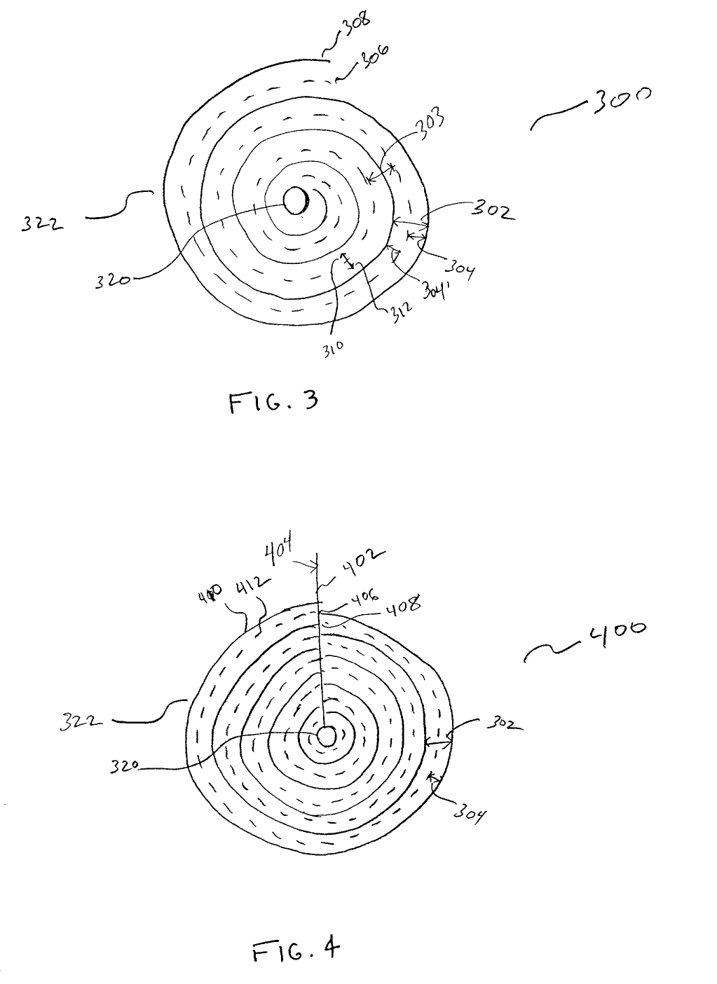

FIG. 3 illustrates an optical disc stamper having interleaved spiral grooves. The first groove, represented by the solid line 308, has a pitch of N 302. The second groove, represented by the dashed line 306, also has a pitch of N 303. When the two grooves are interleaved on a master as shown in this Figure, the combined pitch is N/2 304, 304′. In one embodiment, to produce a micro-lens structure having a repeating physical feature with a repetition period of N, the groove 306 and the groove 308 have different characteristics.

As is well known to one skilled in the art, optical disk masters are typically made on a laser mastering machine. A blank master, consisting of a glass plate coated with photo resist, is rotated below a carriage bearing one or more laser driven exposing devices. The carriage is moved in a linear manner, either continuously or in discrete steps, from the center of the glass plate to the outer edge or in the reverse direction over the rotating glass plate. Continuous motion yields a spiral track. Discrete motion yields concentric circles. The intensities of the laser exposing devices are modulated to introduce be appropriate patterning into the tracks on the master. A Direct Read After Write (DRAW) mastering machine produces similar results with a similar configuration and process but using a photo-polymer that does not require developing in place of the photo-resist.

While a master according to this invention may be fabricated in a number of ways, a most advantageous method uses a laser mastering machine with two laser styluses. The styluses are separated by a distance M*N+N/2, where M is an integer, and are moved in a continuous manner across the blank master to trace out interleaved spirals having the desired pitch. It will be appreciated that the stylus used may take many forms, either currently known or developed in the future, including a diamond tipped etching tool, a laser beam, or an electron beam. The term stylus as used here is intended to mean any physical etching or grooving mechanism, with these being merely examples. It is also possible to create an equivalent master by other methods, for example exposure through one or more masks in the desired patterns.

If the operating parameters of the two styluses are different, two grooves of different geometric characteristics are created. For example, in a laser mastering machine, the etching laser power or focus may be different for the two etching beams. A second method uses a single stylus mastering system to consecutively create the first and second tracks on the master. The stylus initially creates the first track 308 by moving, in a spiral pattern, from the outer edge 322 of the master towards the center 320. The stylus then retreats back to the outer edge 322, moves an offset distance N/2 304 towards the center 320, and begins creating the second track 306 by moving, in a spiral pattern towards the center 320 of the optical medium. In this embodiment, the stylus parameters may be changed between the creation of the two grooves.

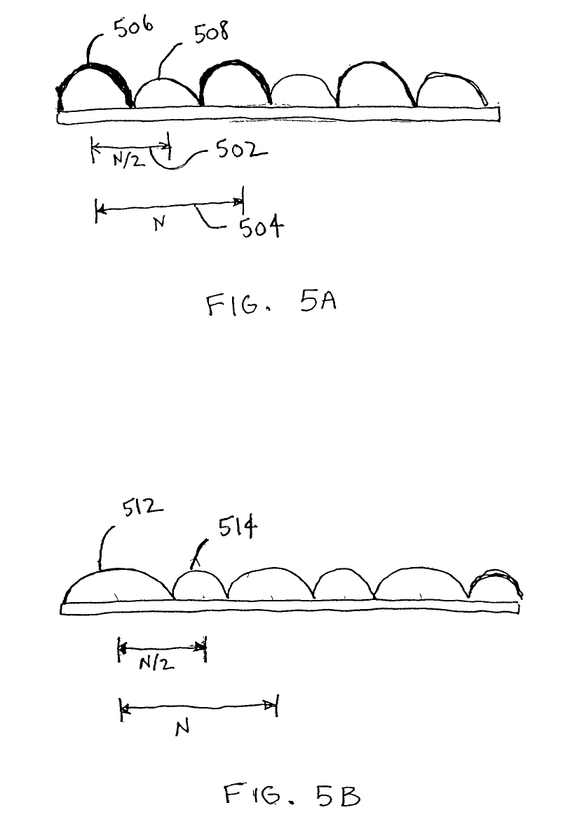

FIG. 4 illustrates an optical disc stamper having a single spiral track. In this embodiment, a master fabrication system (for ultimately producing the stamper) uses a single mastering stylus to create a single spiral groove having a physical pitch of N/2and a virtual pitch of N. In order to create a virtual track pitch of N 302, the mastering machine may alternate the physical parameters of stylus operation with each revolution. In a laser mastering process, for example, the beam that is creating the master may begin groove creation on outer edge 322 at reference line 404 of 400. An outer groove is created as the beam moves in a counter clockwise spiral direction. When the beam reaches reference line 404 (at point 406), the parameters of laser illumination, and thus the physical characteristics of the groove, are changed. In one embodiment, the intensity of the beam is adjusted, such that the next revolution (dashed line 412) will create a track having a groove of different depth than the first revolution (solid line 410). When the second revolution is complete (i.e. the beam reaches reference line 404 at point 408) the beam intensity is returned to its' original level and another revolution is created. This process is repeated for each revolution until the beam reaches the center 320 of the master 400. From the completed master is created the stamper through a serial replication process, and from which a micro-optic structure having two tracks with different micro-lens heights may then be formed. In another embodiment, beam power and focus are both altered to produce adjacent grooves of different width, but approximately the same depth. Cross sections of micro-lens superstructures formed with stampers made with these techniques are illustrated in FIGS. 5A and 5B.

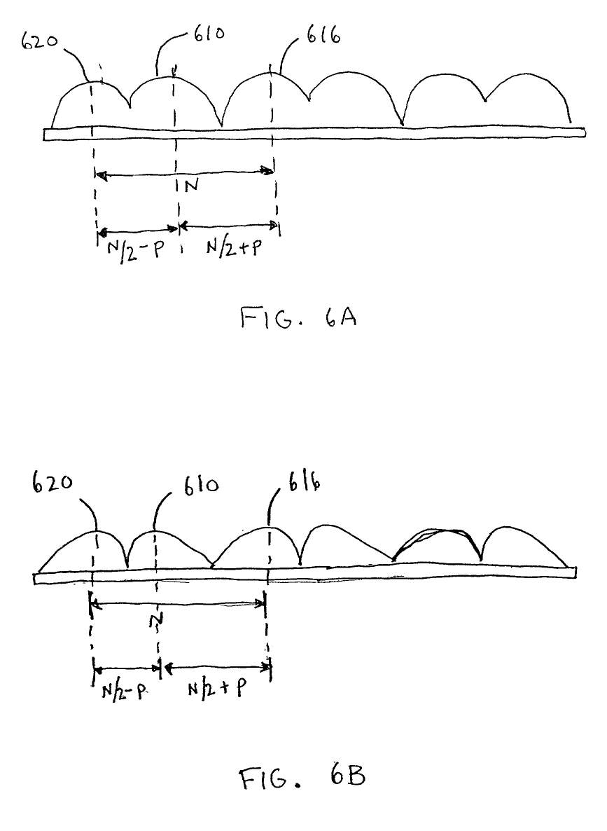

In another embodiment, a dual stylus mastering process is used to fabricate a master having two interleaved spiral grooves wherein the spirals are offset from each other differently in one direction than the other. In this embodiment, the two styluses are separated by slightly less (about 25% is suitable) than the desired physical track pitch during the grooving operation. This produces a slightly wider gap on one side of each spiral than on the other. During this process, the mastering styluses may be controlled to produce grooves that have the same shape, producing a lens superstructure as shown in FIG. 6A, or different shape, producing a lens superstructure as shown in FIG. 6B. The amount of overlap may also be varied.

An alternative approach uses a single stylus that produces one continuous spiral, but for every odd revolution, the stylus is moved outward by a small amount (again about 25% of the desired physical track pitch is suitable), and on every even revolution, is moved back inward by the same amount. As with the dual stylus process, this results in grooves having neighbors on either side of unequal radial distance away.

As is taught in for instance, Principles of Optical Disk Systems on page 194, it is possible to control the depth and the shape of grooves during mastering by modulating the intensity of the mastering lasers. Such control can be made easier by coating the glass substrate of the master with two layers of photo-resist. In the case of photo-resists which become less permanent upon light exposure, the layer adjacent to the glass should be of a slow photo-resist with a thickness equal to the difference in heights of the short and tall lenses, typically about 80 nm. On top of this layer is a second layer of photo-resist, this one being of a fast type and having a thickness equal to the height of the shorter lenses, typically about 200 nm. The short lenses are formed by exposing with a power slightly less than that required to completely expose the faster photo resist. The slight under exposure is chosen to properly shape the apex of the lenses. The tall lenses are formed with a much higher power, nearly sufficient to fully expose the slower photo-resist. In this way, the heights of the individual lenses are controlled mainly by the thicknesses of the photo-resist layers and the curvatures of the lenses are controlled by setting the power to slightly under expose the respective photo-resist. This partial decoupling of the two characteristics makes the mastering process much easier.

A variety of other methods of creating hemicylindrical structures for micro-optical components are described in U.S. patent application Ser. No. ______, entitled “Method for Fabrication of Sub-Micron Microlenses” attorney docket No. CALIME.006A, and filed on even date herewith. The disclosure of the “Method for Fabrication of Sub-Micron Microlenses” application is hereby incorporated by reference in its entirety. The methods of this application could be easily modified to produce masters for micro-lens formation having the desired characteristics described in detail herein.

In the embodiments in which lens height is the distinguishing characteristics of the two track types, it is especially advantageous to choose the difference in heights to suppress crosstalk between adjacent data tracks. It is well known that, in optical disks with flat-bottomed grooves, a reduction in crosstalk between land and groove recordings can be effected by a making the groove depth approximately ⅙ the wavelength of the illuminating light. In the case of micro-lenses, this particular spacing is not necessarily optimal. The optimal spacing is a complicated function of the lens geometry and the thicknesses and materials of the other elements in the optical stack. The optimal spacing is advantageously determined for each particular case by a detailed simulation of the particular parameters and, in fact, is usually determined as one parameter in a multivariate optimization.

In the industry standard DVD players, the tracking information and the data are combined in a single optical path. In the disk structures described herein, the micro-lenses are a very significant component of that path. It is possible to control the relative amplitudes of the tracking and the data channels by carefully selecting the index of refraction of the material of the micro-lenses. Since the data is written to the active layer below the micro-lenses and the tracking information comes from any periodic structure, whether in the micro-lenses or in the data layer below them, enhancing the reflection at the polycarbonate to lens interface will enhance the tracking signal at the expense of the data signal. Since the micro-lenses, by their very nature, enhance the data signal over that experienced by a disk of the conventional design, there is room to tradeoff data channel performance against tracking channel performance. We have found that using a high index material, such as amorphous silicon, for the lenses can enhance the tracking performance and even suppress some disturbances of tracking that are attributable to specific data patterns recorded on the disk.

FIG. 5A illustrates a cross section of an optical storage medium with micro-lenses having different heights for adjacent tracks 506 and 508. According to FIG. 5A, the first micro-lens 506 has a height that is greater than the second micro-lens 508. This produces a strong repeating pattern with period N, even though the track pitch is N/2. Accordingly, the physical track pitch is N/2 502, while the virtual track pitch (which can be used by an optical disc reader) is N 504.

FIG. 5B illustrates a cross section of an optical disc having width modulated tracks. In this case, lens 512 has a larger width than lens 514. As with the embodiment of FIG. 5A, a repeating pattern of period N is formed in the lens superstructure, even though the physical track pitch is N/2.

FIGS. 6A and 6B show lens structures suitable for embodiments wherein the distance between adjacent tracks is different on one side than the other. In both cases, a given track 610 has one adjacent track 616 spaced N/2+P on one side, and the other adjacent track 620 spaced N/2−P on the other side. Once again, the overall effect is to place a repeating pattern of period N to the superstructure. In one advantageous embodiment, N/2 is about 370 nm, and P is between about 50-100 nm.

It will be appreciated that the embodiments of FIGS. 5 and 6 may each comprise either interleaved spiral tracks, a single spiral track, such as shown in either FIG. 3 or 4, or, alternatively, may be concentric circular tracks.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. An optical data storage medium comprising:
a storage layer having one or more data storage tracks thereon which define a data track pitch, and
a micro-lens array positioned proximate to said one or more data storage tracks, wherein said micro-lens array comprises a periodic structure defining at least first and second repeating periods, and wherein said periodic structure induces a virtual track pitch having a pitch which is different than said data track pitch.

2. The optical data storage medium of claim 1, wherein said micro-lens array comprises first and second interleaved lenses.

3. The optical data storage medium of claim 2, wherein said interleaved lenses are spiral lenses.

4. The optical data storage medium of claim 2, wherein said first lens is taller than said second lens.

5. The optical data storage medium of claim 2, wherein said first lens is wider than said second lens.

6. The optical storage medium of claim 2, wherein said first lens is disposed a first distance from said second lens in a first direction and said first lens is disposed a second distance from said second lens in a second direction.

7. The optical data storage medium of claim 1, wherein said micro-lens array comprises a single lens.

8. The optical data storage medium of claim 7, wherein said lens is a spiral lens.

9. The optical storage medium of claim 7, wherein a portion of said spiral lens located between first and second adjacent portions is disposed a first distance from an adjacent portion in a first direction and is disposed a second distance from an adjacent portion in a second direction.

10. The optical data storage medium of claim 7, wherein a first portion of said single spiral lens is taller than a second portion of said single spiral lens.

11. The optical data storage medium of claim 7, wherein a first portion of said single spiral lens is wider than a second portion of said single spiral lens.

12. The optical data storage medium of claim 1, wherein said micro-lens array comprises a series of concentric circular lenses.

13. The optical data storage medium of claim 12, wherein a first portion of said lenses have a first height and a second portion of said lenses have a second height.

14. The optical data storage medium of claim 12, wherein a first portion of said lenses have a first width and a second portion of said lenses have a second width.

15. An optical storage device comprising:
a far field optical pick-up unit and an optical data storage medium, said optical data storage medium comprising:
a storage layer; and
a plurality of adjacent track portions for storing optical artifacts on said storage layer, wherein said track portions define a radial track pitch of N/2 microns, and wherein said optical artifacts are readable by an optical drive configured for tracking an N micron track pitch.

16. The optical storage medium of claim 15, wherein N is approximately 0.74 micrometers.

17. The optical storage medium of claim 15, wherein said plurality of adjacent track portions are formed from two interleaved spiral tracks.

18. The optical storage medium of claim 15, wherein said plurality of adjacent track portions are formed from a plurality of unconnected concentric circular tracks.

19. The optical storage medium of claim 15, wherein said plurality of adjacent track portions are formed from a single spiral track.

20. The optical storage medium of claim 15, wherein at least some of said adjacent track portions are positioned beneath a micro-lens superstructure, and wherein different portions of said superstructure over different adjacent tracks have different physical characteristics.

21. An optical storage medium comprising:
a first track for recording optical artifacts having a track pitch of N microns;
a second track for recording optical artifacts having a track pitch of N microns;
wherein said first track and said second track are interleaved such that there is an average track pitch of N/2 microns between said first and second tracks.

22. The optical storage medium of claim 21, wherein said first track is disposed a first distance from said second track in a first direction and said first track is disposed a second distance from said second track in a second direction;

23. The optical storage medium of claim 21, wherein said first and second tracks are positioned beneath a first and second micro-lens, respectively.

24. The optical storage medium of claim 21, wherein said first micro-lens has a first height and said second track has a second height.

25. The optical storage medium of claim 21, wherein said first micro-lens has a first shape and said second micro-lens has a second shape.
